(19) United States
(12) Patent Application Publication
(10) Pub. No.: US 2022/0175092 A1
(43) Pub. Date: Jun. 9, 2022

(54) DEVICE FOR PROTECTING SOLE OF FOOTWEAR AGAINST DAMAGE CAUSED FROM IMPACTING FOOT-DRIVEN TOOL

(71) Applicant: 2020480 ALBERTA LTD., Calgary (CA)

(72) Inventor: Hussein Dahrouj, Calgary (CA)

(21) Appl. No.: 17/603,421

(22) PCT Filed: Apr. 13, 2020
(86) PCT No.: PCT/CA2020/050491

§ 371 Date: Oct. 13, 2021

Related U.S. Application Data
(60) Provisional application No. 62/835,353, filed on Apr. 17, 2019.

(51) Int. Cl. A43C 13/12; A43C 13/02; A43D 97/00

(52) U.S. Cl. CPC A43C 13/12; A43D 97/00; A43C 13/02

(57) ABSTRACT

A device for protecting footwear includes a base with length less than a length of the sole of the footwear to be protected and a width greater than a width of the sole. The base has a top surface for placement adjacent the sole of the footwear and a bottom surface for abutting against a foot-driven tool. A right sidewall extends upward from the right side of the base, and a left sidewall extends upward from the left side of the base. A strap is attached to the right sidewall and the left sidewall for looping around the footwear to hold the top surface of the base adjacent the sole of the footwear. In this way, a user can impact the foot-driven tool with the device instead of the sole of the footwear thereby protecting the sole against damage, and the sidewalls prevent the device laterally sliding off the sole.

### CROSS-REFERENCE TO RELATED APPLICATIONS

This application claims the benefit of priority of U.S. Provisional Application No. 62/835,353 filed Apr. 17, 2019, which is incorporated herein by reference.

### BACKGROUND OF THE INVENTION

### (1) Field of the Invention

The invention pertains generally to a device for protecting work boots utilized in the construction and irrigation industries. More specifically, the invention pertains to a device that is removably fastened to footwear for preventing damage caused by a foot-driven tool such as a shovel impacting the sole of the footwear while digging or trenching.

### (2) Description of the Related Art

Trenching is a common practice for many industries. When digging, workers typically step on an upper edge of a shovel blade and use their bodyweight to push the shovel blade into the ground. Although this is effective, the worker damages the rubber sole of their footwear from repetitive use.

FIG. 1 shows damage 10 to the sole of a work boot 12 from trenching according to the prior art. If the user continues to wear damaged footwear while trenching, the user may end up causing serious damage to the bottom of their foot when the user strikes the shovel with their foot. For example, the upper edge of the shovel blade may eventually pierce through a hole in the sole of the footwear and cut the user's foot.

High quality work boots are expensive and a worker may end up going through multiple pairs in a given season due to sole damage. Some specialized models of shovels and spades come with a rubber foot pad mounted on the upper end of the shovel blade for digging, but most typical shovels do not have such feature. Workers also use many different types of shovels for a given job and would need to buy various types of upgraded shovels at great cost to replace their otherwise-still-working older ones.

### BRIEF SUMMARY OF THE INVENTION

According to an exemplary embodiment of the invention there is disclosed a sole saver device for protecting the sole of footwear when digging. The sole saver device includes a plate having a u-shape with flat bottom and sidewalls, traction ridges, and a strap for removably fastening the sole saver to footwear. The strap may be removably fastened to the metal plate using rivets, snaps or H-brackets. The sole saver prevents damage to the footwear when trenching.

According to an exemplary embodiment of the invention there is disclosed a sole saver device for protecting a sole of a footwear against damage caused from impacting a foot-driven tool. The device includes a base having a front end and a back end wherein a length of the base between the front end and the back end is less than a length of the sole of the footwear. The base further has a right side and a left side wherein a width of the base between the right side and the left side is greater than a width of the sole of the footwear. The base further has a top surface facing an upward direction for placement adjacent the sole of the footwear and a bottom surface facing a downward direction for abutting against the foot-driven tool during usage of the foot driven tool. A right sidewall extends in the upward direction from the right side of the base, and a left sidewall extends in the upward direction from the left side of the base. A strap is attached to the right sidewall and the left sidewall for looping around the footwear to thereby hold the top surface of the base adjacent the sole of the footwear. While the strap is holding the top surface of the base adjacent the sole of the footwear, a user can impact the foot-driven tool with the device instead of the sole of the footwear thereby protecting the sole against damage, and the right sidewall and the left sidewall prevent the device from laterally sliding off the sole of the footwear.

According to an exemplary embodiment of the invention there is disclosed a method of manufacturing the above sole saver device. The method includes cutting a substantially rectangular piece of metal, drilling a plurality of holes on each of a right section and a left section the substantially rectangular piece of metal, and bending up the right section and the left section of substantially rectangular piece of metal to thereby respectively form the right sidewall and the left sidewall.

In an exemplary embodiment, the sole saver device not only protects the sole of footwear when digging, it also increases productivity by keeping the leg and foot from flexing over the shovel on impact, which helps dramatically to eliminate foot soreness and reduce shock impact and injury. The combination of these factors increases productivity. The sole saver device essentially acts like a hammer on one's boot where the edge of the shovel blade is the nail.

These and other advantages and embodiments of the present invention will no doubt become apparent to those of ordinary skill in the art after reading the following detailed description of preferred embodiments illustrated in the various figures and drawings.

### BRIEF DESCRIPTION OF THE DRAWINGS

The invention will be described in greater detail with reference to the accompanying drawings which represent preferred embodiments thereof:

FIG. 1 shows damage to the sole of a work boot from trenching according to the prior art.

FIG. 2 illustrates a perspective view of a device for protecting a sole of a piece of footwear against damage caused from impacting a foot-driven tool according to an exemplary embodiment.

FIG. 3 illustrates a top down view of the device of FIG. 2 with the buckle unattached.

FIG. 4 illustrates a sideview of the device of FIG. 1 installed on a work boot according to an exemplary embodiment.

FIG. 5 illustrates a perspective view of a method of utilizing the device for protecting the sole of footwear against damage caused from impacting a foot-driven tool such as a shovel according to an exemplary embodiment.

FIG. 6 illustrates a front view of the base and sidewalls of the device of FIG. 1.

FIG. 7 illustrates a top down view of the base and sidewalls of the device of FIG. 1.

FIG. 8 illustrates a back view of the base and sidewalls of the device of FIG. 1.

FIG. 9 illustrates a bottom up view of the base and sidewalls of the device of FIG. 1.

FIG. 10 illustrates an exploded view of a means of attaching the strap to a sidewall according to an exemplary embodiment.

FIG. 11 shows the strap attached to the sidewall utilizing the technique of FIG. 10.

FIG. 12 illustrates an exploded view of an alternate means of attaching the strap to a sidewall according to an exemplary embodiment.

FIG. 13 shows the strap attached to the sidewall utilizing the technique of FIG. 10.

FIG. 14 illustrates yet another embodiment of strap attachment being provided by a H-bracket.

FIG. 15 illustrates a front view of the base and sidewalls illustrating a plurality of protrusions on the bottom surface of the base for facilitating gripping and friction with the foot-driven tool according to an exemplary embodiment.

FIG. 16 illustrates a front view of the base and sidewalls illustrating a plurality of protrusions on the upper surface of the base for facilitating gripping and friction with the sole of the user's footwear according to an exemplary embodiment.

FIG. 17 illustrates a top view of the base and sidewalls illustrating a plurality of holes through the base for simultaneously increasing friction on both the top and the bottom surfaces of the base according to an exemplary embodiment.

FIG. 18 illustrates a bottom view of the device while installed on a piece of footwear where the bottom surface of the base has a plurality of recesses for increasing friction according to an exemplary embodiment.

FIG. 19 illustrates a bottom view of the device while installed on a piece of footwear where the bottom surface of the base has a plurality of etched groves configured in a grid pattern for increasing friction according to an exemplary embodiment.

FIG. 20 illustrates a bottom view of the device while installed on a piece of footwear where the bottom surface of the base has a plurality of outdents for increasing friction according to an exemplary embodiment.

FIG. 21 illustrates a top view of the device including an indicator showing a foot direction to guide the user to position the device with the front end of the base directed toward a front end of the footwear, according to an exemplary embodiment.

FIG. 22 shows another example of an indicator showing a foot direction formed by arrows facing toward the front end of the base according to an exemplary embodiment.

FIG. 23 illustrates a front view of the device where the strap is a single elastic strap permanently attached between both the right and left sidewalls according to an exemplary embodiment.

FIG. 24 illustrate front view of the device where the strap is formed by first and second strap parts with a single tongue buckle therebetween for attaching the strap parts together according to an exemplary embodiment.

FIG. 25 illustrate front view of the device where the strap is formed by first and second strap parts with a snap buckle therebetween for attaching the strap parts together according to an exemplary embodiment.

FIG. 26 shows a steel plate being utilized to manufacture a device for protecting the sole of footwear according to an embodiment where the sidewalls are angled with respect to one another according to an exemplary embodiment.

FIG. 27 shows a steel plate being utilized to manufacture a device for protecting the sole of footwear according to an embodiment where the sidewalls are parallel one another according to an exemplary embodiment.

FIG. 28 illustrates a bottom view of the device while installed on a piece of footwear where the bottom surface of the base has a plurality of etched groves configured as a plurality of lateral lines for increasing friction according to an exemplary embodiment.

### DETAILED DESCRIPTION

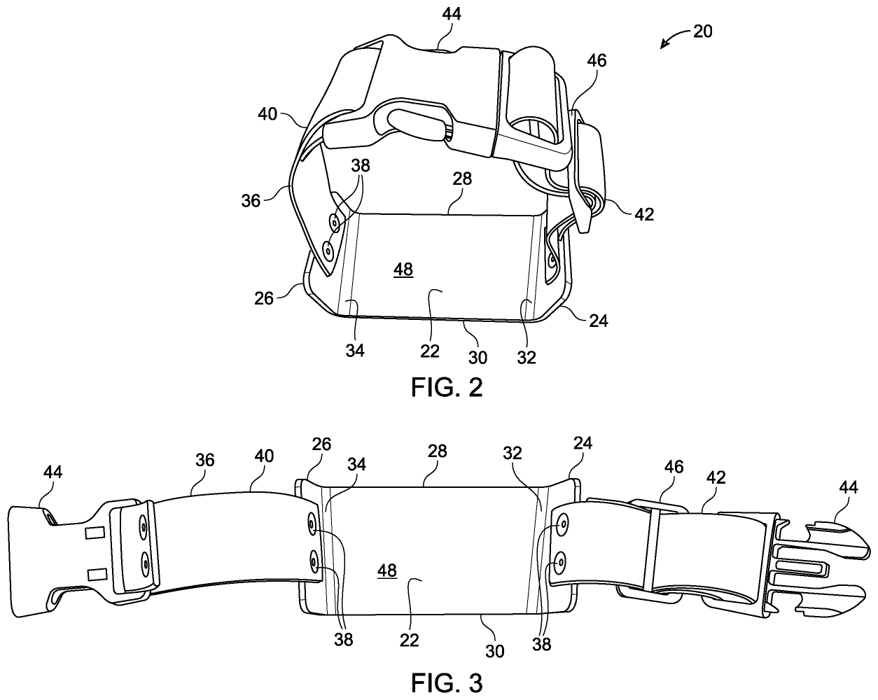

FIG. 2 illustrates a perspective view of a device 20 for protecting a sole of a piece of footwear against damage caused from impacting a foot-driven tool. The device 20 includes a base 22 of rigid structure with a right sidewall 24 and a left sidewall 26. Each of the sidewalls 24, 26 respectively extends in the upward direction from the right and left sides of the base 22.

The base 22 has a front end 28 and a back end 30, where the front end 28 is pointing toward the front of the footwear (i.e., toward the user's toes) and the back end 30 of the base 22 is pointing toward the back of the footwear (i.e., toward the user's heel). However, the length of the base 22 between the front end 28 and the back end 30 is much less than the total length of the sole of the footwear to be protected. For instance, in some embodiments, the length of the base 22 is around two inches.

The base 22 further has a right side 32 and a left side 34 where the sidewalls 24, 26 begin to curve upwards. The width of the base 22 between the right and left sides 32, 34 is configured to be greater than the width of the sole of the footwear to be protected. The width of the base 22 also changes from the back end 30 to the front end 28 such that it will better fit the typical sole profile of a work boot. For instance, in some embodiments, the back end 30 width of the flat portion of the base 22 between the sidewalls 24, 26 is approximately three inches, and the front end 28 width of the base 22 between the sidewalls 24, 26 is approximately four inches.

The device 20 further includes a strap 36 attached to the right sidewall 24 and the left sidewall 26 for looping around the footwear to thereby secure the device 20 to the footwear. Each of the sidewalls 24, 26 includes two holes in this embodiment, and two snaps 38 are utilized on each side to secure the strap 36 to the sidewalls 24, 26.

The strap 36 in this embodiment is formed by two strap pieces 40, 42 with a snap buckle 44 therebetween allowing the user to easily open the strap 36 for installing and removing the device 20 onto the footwear, and one or more tightening clips 46 allowing the user to adjust the diameter of the loop formed by the strap 36 when the buckle 44 is closed to secure the device 20 to footwear of different sizes.

FIG. 3 illustrates a top down view of the device 20 of FIG. 2 with the buckle 44 unattached. As illustrated, the base 22 and sidewalls 24, 26 in this embodiment are formed by an integral piece of metal being a stainless steel plate having a thickness of 18 to 16 gauge. The plate is substantially rectangular (with rounded corners) and is folded upwards on the right and left sides 32, 34 to thereby form the sidewalls 24, 26. There are two fold lines being the right and the left sides 32, 34 of the base 22, and the fold lines 32, 34 in this embodiment are not parallel. The angle of the fold lines on the sides 32, 34 causes the flat section of the base 22 to be wider at the front end 28 than at the back end 30.

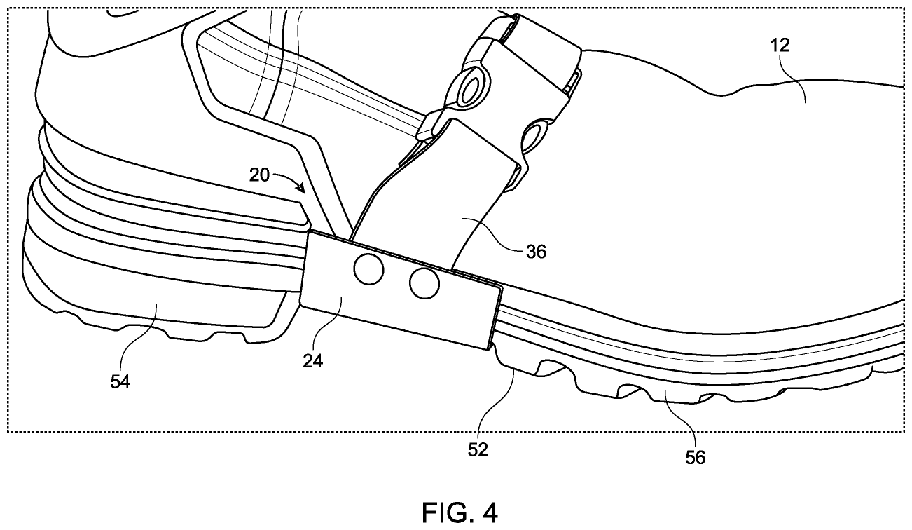

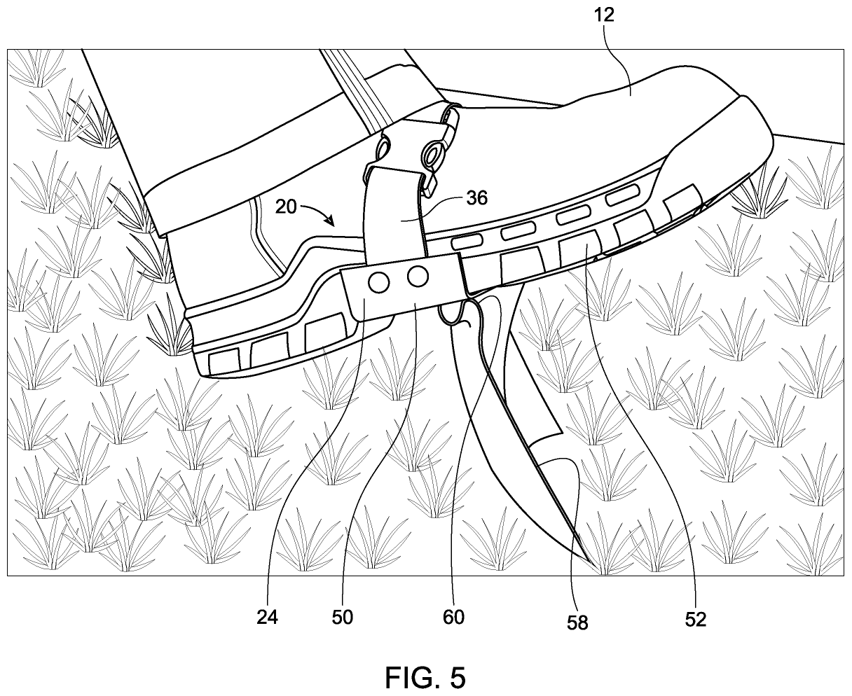

A top surface 48 of the base 22 faces in an upward direction for placement adjacent the sole of the footwear to be protected. The bottom surface 50 of the base 22 (not shown in FIG. 3, but illustrated later in FIG. 9, for example) faces in a downward direction for abutting against a foot-driven tool such as a shovel 58 (see FIG. 5) utilized for trenching or other digging work.

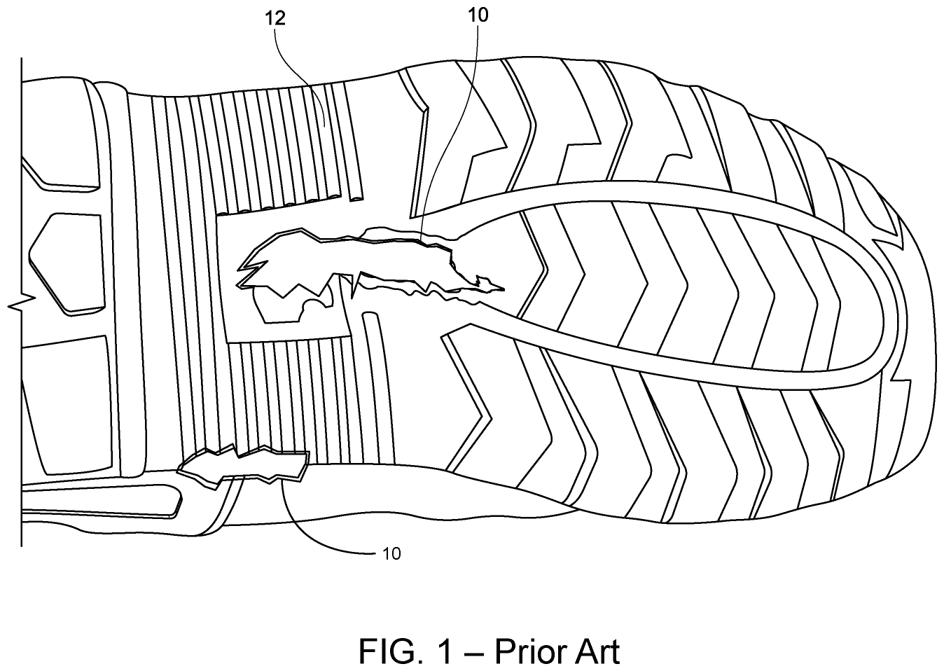

FIG. 4 illustrates a sideview of the device 20 of FIG. 1 installed on a work boot 12 according to an exemplary embodiment. The strap 36 holds device 20 in position on the bottom of the work boot 12 with the top surface 48 of the base 22 adjacent the boot sole 52 and the bottom surface 50 of the base 22 toward the ground. As shown, the length of the base 22 fits nicely in the gap between the heel 54 of the footwear 12 and the forward part of the outsole 56, which are the two parts of the boot 12 that normally impact the ground when the user walks. In this way, the user is not usually walking around directly on the device 20 when it is installed, which increases comfort and prevents the need to always remove the device when not trenching.

The sidewalls 24, 26 extend upwards on either side of the boot 12 and thereby both protect the corners and sides of the sole 52 covered by the device 20, and further prevent the device 20 from laterally slipping off the boot 12. The length of the boot sole 52 along with its shape including the downward extending heel 54 and downward extending forward outsole portions 56 help hold the device 20 in position lengthwise and prevent it from slipping off in either the forward or backward directions.

FIG. 5 illustrates a perspective view of a method of utilizing the device 20 for protecting the sole 52 of footwear 12 against damage caused from impacting a foot-driven tool such as any type of shovel 58 according to an exemplary embodiment. As shown, when trenching, the user can impact the upper edge 60 of the shovel blade with the device 20 (e.g., either the bottom surface 50 of the base 22 and/or the outer surfaces of the sidewalls 24, 26 can be used to press on the shovel blade edge 60) instead of the more vulnerable sole 52 of the footwear. In this way, the device 20 shields the sole 52, distributes the impact with the shovel blade 60 across a much larger surface area of the sole 52, and generally protects the sole 52 of the footwear 12 against damage during repetitive and ongoing trenching.

By utilizing the device 20, the user can use their regular boots 12 for trenching and can further utilize older model shovels 58 and other foot-driven tools (e.g., rakes, spades, aerators, hoes, forks, tillers, etc.) without having to worry about damage to the footwear soles or associated risks of foot injury due to damaged footwear. According to advantageous embodiments, the device 20 makes adequate contact with the shovel blade 60 so that the footwear 12 does not fold over the shovel blade 60 when the user drives downward with their bodyweight. The user simply slips on or clips on the device 20 when needed and stores after use. The user may also continue to wear the device 20 when temporarily not in use such as when the user is on breaks. The user can also easily switch between different types of shovels 58 and spades and other tools without any further modifications to the tool. The device 20 is lightweight making it possible for the user to wear it even when they are not digging, and the device 20 can also help to prevent sore feet by the end of a full day of trenching. Beneficially, the example dimensions provided above fits many typical sizes of footwear 12 (e.g., boot sizes 11-15) and types of footwear 12 that the user may wear when digging. The dimensions can also be adjusted for larger (or smaller) sized boots 12 as required.

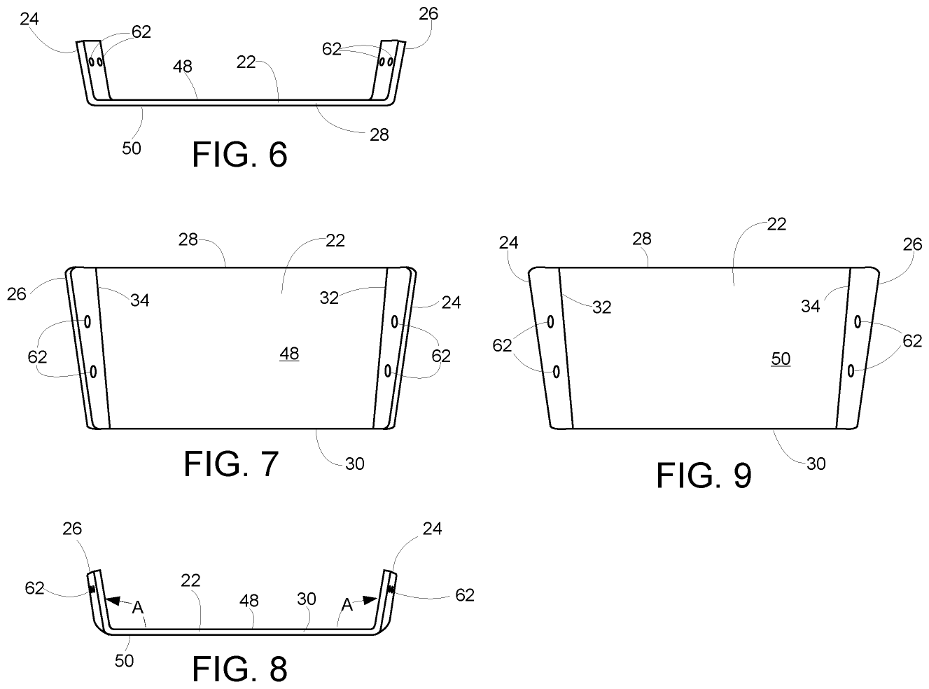

FIG. 6 illustrates a front view of the base 22 and sidewalls 24, 26 of the device 20 of FIG. 1. As illustrated, the base 22 and sidewalls 24, 26 are formed by an integral piece of rigid material such as stainless steel. The sidewalls 24, 26 curve upwards on the base right and left sides 32, 34. Holes 62 are drilled on the sidewalls for attaching the strap using snaps, rivets, or other attachments.

FIG. 7 illustrates a top down view of the base 22 and sidewalls 24, 26 of the device 20 of FIG. 1. As illustrated, the sidewalls 24, 26 fold upwards along right and left side lines 32, 34 that are not parallel—instead the base side lines 32, 34 diverge away from one another in the front direction (toward front end 28) and converge toward one another in the back direction (toward back end 30).

FIG. 8 illustrates a back view of the base 22 and sidewalls 24, 26 of the device of FIG. 1, and FIG. 9 illustrates a bottom up view of the base 22 and sidewalls 24, 26 of the device of FIG. 1. These two figures show the same features from different views including that the sidewall holes 62 extend entirely through the sidewalls 24, 26.

The sidewalls 24, 26 may form any angle with a base 22 of the rigid plate 98 such that it can be adapted to different size and shapes of footwear 12. However, as shown in FIG. 8, preferably the angle A is substantially one hundred and ten degrees from the top surface of the base. In some embodiments, the angle A is between one-hundred degrees and one hundred and twenty degrees such that the sidewalls extend outward away from one another in addition to extending in the upward direction.

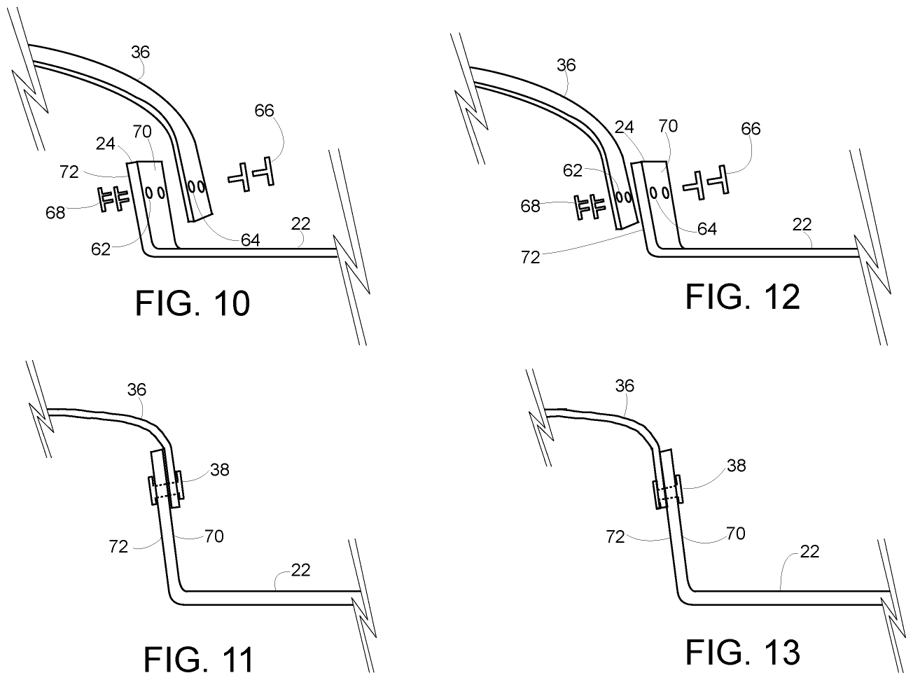

FIG. 10 illustrates an exploded view of a means of attaching the strap 36 to a sidewall 24, 26 according to an exemplary embodiment. In the following description, the right sidewall 24 will be utilized as an example; however, it is to be understood the same approach may also be utilized for the left sidewall 26. The technique illustrated in FIG. 10 generally corresponds to that utilized in FIG. 1 and involves the strap 36 being mounted on the inner facing surface 70 of the sidewall 24.

The strap 36 includes two holes 64 that correspond in position and size with the sidewall holes 62. A pair of snaps 38 are utilized to secure the strap 36 in position on the sidewall, where each snap 38 is formed by a male end 66 and a female end 68 that lock together. FIG. 11 shows the strap 36 attached to the sidewall 24 utilizing the technique of FIG. 10. Attaching the strap 36 to the inner surface 70 of the sidewall 24 is beneficial in some embodiments to protect the strap 36 from abrasion if the user impacts the outer surface 72 of the sidewall 24 against the sharp edge 60 of the shovel 58 or other foot-driven tool.

FIG. 12 illustrates an exploded view of an alternate means of attaching the strap 36 to a sidewall 24 according to an exemplary embodiment, and FIG. 13 shows the strap 36 attached to the sidewall 24 utilizing the technique of FIG. 10. In this case, the strap 36 is attached in a similar manner as described above for FIGS. 10 and 11; however, the strap 36 is now adjacent the outer surface 72 of the sidewall 24. This embodiment is usually not preferred due to possible strap 36 damage over time; however, there are applications where damage to the strap 36 may actually be caused by the footwear 12 itself and the embodiment of FIGS. 12 and 13 is therefore included herein for completeness.

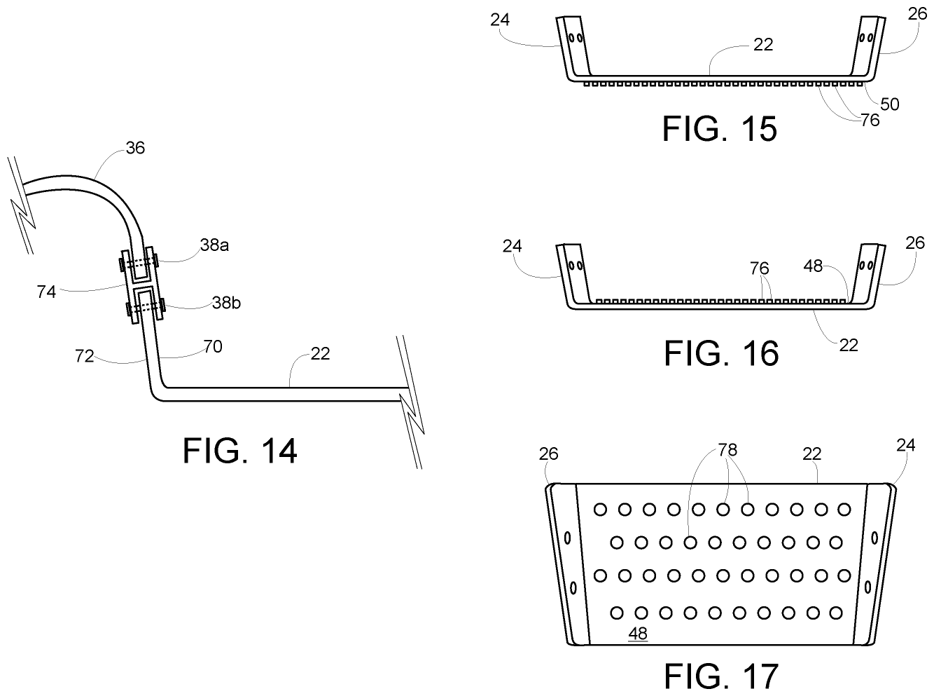

FIG. 14 illustrates yet another embodiment of strap 36 attachment being provided by a H-bracket 74. As shown, the H-bracket 74 is in the shape of the capital letter “H” and has two sets of snaps 38, upper and lower 38a,b. The lower snap 38b set holds the H-bracket 74 to the sidewall 24 and the upper snap set 38a holds the H-bracket 74 to the strap 36. Although the embodiment of FIG. 14 requires the H-bracket 74 and double the snaps 38 (i.e., four snap pairs instead of two), the embodiment of FIG. 14 is beneficial to raise the strap 36 out of the “danger zones” on both the inner and outer surfaces 70, 72 such that it is unlikely to be impacted by either the user's footwear 12 or the foot-driven tool 12. Thus, damage to the strap 36 over time may be beneficially reduced when utilizing the embodiment of FIG. 14.

FIG. 15 illustrates a front view of the base 22 and sidewalls 24, 26 illustrating a plurality of protrusions 76 on the bottom surface 50 of the base 22 for facilitating gripping and friction with the foot-driven tool 12 according to an exemplary embodiment. In this embodiment, the protrusions 76 are roughly ⅛ inch long and spaced in a grid with about ⅛ inch spacing covering the bottom surface 50. In this way, the top edge 60 of the shovel blade 58 other tool is prevented from slipping across the bottom surface 50 of the base 22.

FIG. 16 illustrates a front view of the base 22 and sidewalls 24, 26 illustrating a plurality of protrusions 76 on the top surface 48 of the base 22 for facilitating gripping and friction with the sole 52 of the user's footwear 12. Although the right and left sidewalls 24, 26 prevent the device 20 from laterally slipping off the sole 52 of the footwear 12 while the strap 36 is holding the top surface 48 of the base 22 adjacent the sole 52 of the footwear 12, on some types of footwear 12 the device 20 may still slip lengthwise. This may occur, for example, when the device 20 is utilized on a type of footwear 12 that has a substantially flat outsole 52 surface. Unlike the sole 52 shape of the work boot 12 shown in FIG. 4 that allows the device 20 to be generally held in position lengthwise by the heel 54 of the boot 12 and the lower outsole 56 in the front of the boot 12, if these structures 54, 56 of the footwear 12 are not present and the entire sole 52 is instead flat, the device 20 may slide either forwards or backwards during use. The protrusions 76 shown in FIG. 16 increase the friction and beneficially help hold the device 20 in position in these situations.

FIG. 17 illustrates a top view of the base 22 and sidewalls 24, 26 illustrating a plurality of base holes 78 through the base 22 for simultaneously increasing friction on both the top and the bottom surfaces 48, 50 of the base 22 according to an exemplary embodiment. The holes 78 further provides for drainage when working with wet conditions and help prevent water from getting trapped between the upper surface 48 of the base 22 and the sole 52 of the footwear 12. The holes 78 also reduce the weight of the device 20. The holes 78 may be punched or drilled out in different embodiments.

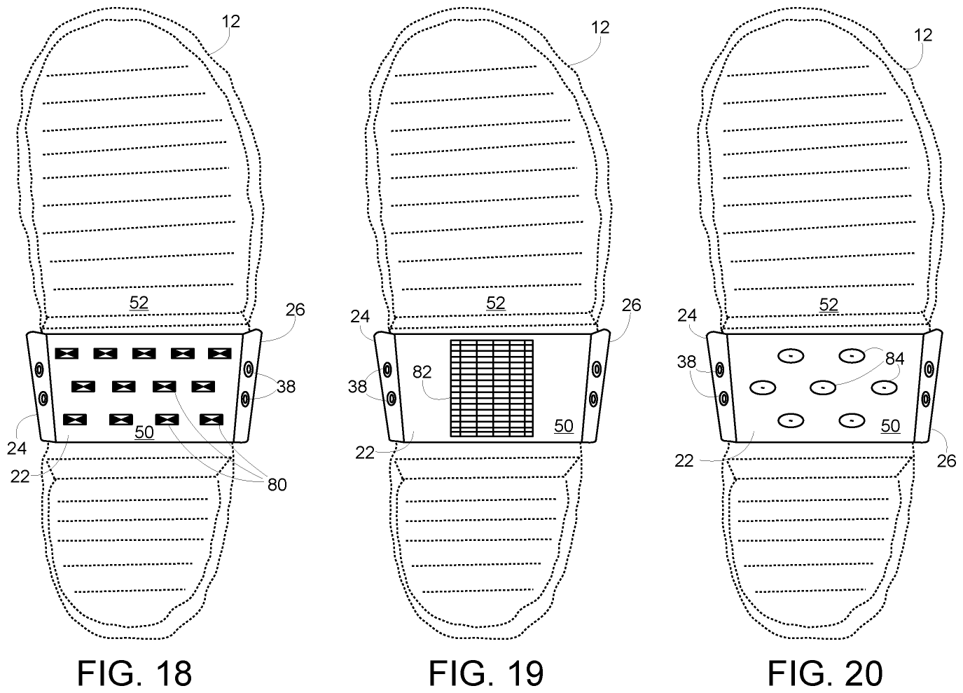

FIG. 18 illustrates a bottom view of the device 20 while installed on a piece of footwear 12 where the bottom surface 50 of the base 22 has a plurality of recesses 80 for increasing friction according to an exemplary embodiment. In this embodiment, rather than protrusions 76, the friction increasing means are plurality of indents stamped into the bottom surface and thereby forming recesses 80. The recesses 80 are arranged in a grid pattern and help prevent slippage of the foot-drive tool 58 against the bottom surface 50 of the base 22.

FIG. 19 illustrates a bottom view of the device 20 while installed on a piece of footwear 12 where the bottom surface 50 of the base has a plurality of etched groves 82 configured in a grid pattern for increasing friction according to an exemplary embodiment. In this embodiment, the etched groves 82 are laser etched; however, any other type of etching may be utilized as desired. The groves 82 are formed by lines drawn in a grid pattern and again help to increase friction and prevent slippage of the tool 58 when impacting the bottom surface 50 of the base 22.

For example, FIG. 28 illustrates a bottom view of the device 20 while installed on a piece of footwear 12 where the bottom surface 50 of the base has a plurality of etched groves 82 configured as a plurality of lateral lines for increasing friction according to an exemplary embodiment. Any number of lines may etched in the surface. In some embodiments, a method of manufacturing the lateral grove lines 82 involves installing a plurality of blades on a table saw. For instance, to cut out the five lines 82 illustrated in FIG. 28, five saw blades are installed with a spacer between each blade corresponding to the distance between the lines 82. The bottom surface 50 of the base is then placed face up on the table saw top and the blades are lowered down to score the surface with a desired depth of the grove lines 82.

FIG. 20 illustrates a bottom view of the device 20 while installed on a piece of footwear 12 where the bottom surface 50 of the base 22 has a plurality of outdents 84 for increasing friction according to an exemplary embodiment. In this embodiment, the outdents 84 are protrusions on the bottom surface 50 that are formed by dents stamped into the upper surface 48 of the base 22. The dents form indents on the upper surface 48 and outdents 84 on the bottom surface 50; they thereby beneficially help to increase friction and prevent slippage on both the upper and lower surfaces 48, 50.

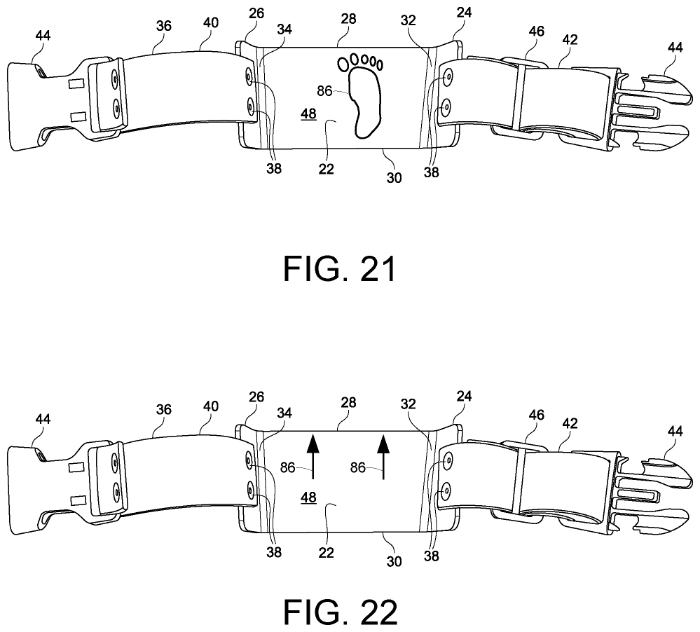

FIG. 21 illustrates a top view of the device 20 including an indicator 86 showing a foot direction to guide the user to position the device 20 with the front end 28 of the base 22 directed toward a front end of the footwear 12. In this embodiment, the front end 28 of the device 20 has a wider width than the back end 30 of the device 20. This is designed to better match the changing width of most footwear 12 that is narrow in a center area of the sole 52 where the back end 30 of the device 20 is positioned, and wider in the front where the device 20 extends in the forward direction.

Installing the device 20 on the footwear 12 in the opposite orientation may be uncomfortable to the user and may in some cases cause rubbing damage to the sides of the sole 52 where the sole 52 is squished between the sidewalls 24, 26 at the narrower width. Thus, the indicator 86 helps the user quickly ascertain which end of the base 22 is the front end 28 (and likewise which end is the back end 30).

FIG. 21 illustrates the indicator 86 being a diagram of a human foot with toes toward the front end 28. FIG. 22 shows another example where the indicator 86 includes arrows facing toward the front end 28. Text may also be included on the upper surface 48 of the base 22 and orientated such that the text is readable when the front end 28 of the base pointing in front of the user.

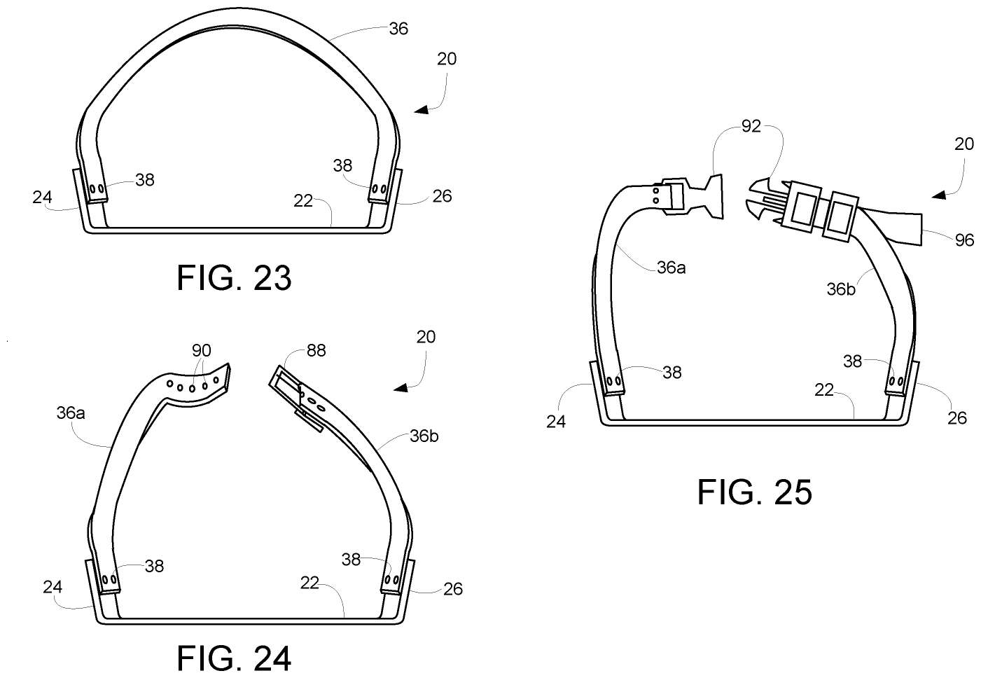

FIG. 23 illustrates a front view of the device 20 where the strap 36 is a single elastic strap 36 permanently attached between both the right and left sidewalls 24, 26. In this embodiment, the user can slip the device 20 on and off their footwear 12 without requiring undoing the strap 36. The strap 36 may be any elastic type material that provides sufficient stretch and elasticity to both stretch around the footwear 12 on insertion/removal and to hold the device 20 is position such that the top surface 48 of the base 22 is securely adjacent the sole 52 of the footwear 12 to be protected. In some embodiments, the material used is a high strength elastic webbing and/or nylon webbing.

FIGS. 24 and 25 illustrate front views of the device 20 where the strap 36 is formed a first strap part 36a attached to the right sidewall 24, a second strap part 36b attached to the left sidewall 26, and a means for attaching the first strap part and the second strap part together.

In the embodiment of FIG. 24, the means for attaching is a single tongue buckle 88. The user can tighten the strap 36 by selecting one of the tongue holes 90 provided on the opposite strap part 36b when doing up the buckle 88.

In the embodiment of FIG. 25, the means for attaching is a snap buckle 92 and the strap tightening means are the friction clips 94 through which a free end 96 strap 36b is pulled to a desired tightness.

The buckle 88, 92 embodiments of FIGS. 24 and 25 are beneficial to provide a more secure attachment of the device 20 to the footwear 12. In addition to elastic materials, the strap pieces 36a,b of FIGS. 24 and 25 may also utilize much stronger, non-elastic materials such as leather or nylon strapping.

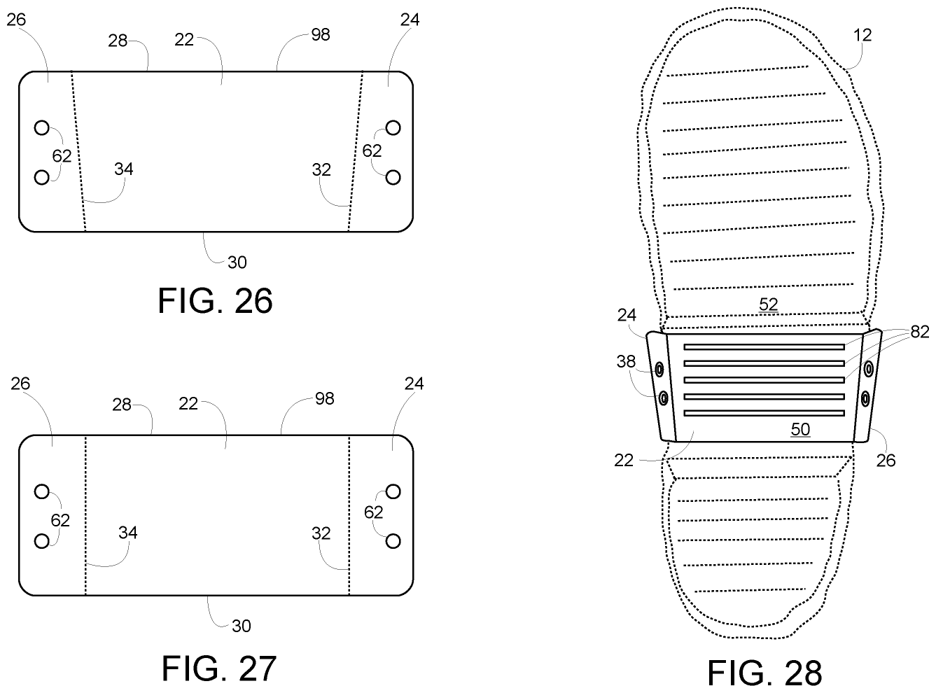

FIG. 26 shows a steel plate 98 being utilized to manufacture a device 20 for protecting the sole of footwear according to an embodiment where the sidewalls 24, 26 are angled in a symmetrical but non-parallel manner according to an exemplary embodiment. A method of manufacturing the device 20 includes cutting a substantially rectangular piece of metal 98 as shown in FIG. 26. A plurality of sidewall holes 62 are drilled on each of a right section and a left section and then the right section and the left section are bent upwards along fold lines 32, 34 to thereby respectively form the right sidewall 24 and the left sidewall 26. A first end of the strap 36 is attached to right sidewall 24 and a second end of the strap 36 is attached to the left sidewall 26.

As shown in FIG. 26, the fold lines 34, 32 are substantially straight and configured such that the right sidewall 24 and the left sidewall 26 are angled away from each other at the front end 28 and are angled toward each other at the back end 30. In this way, the width of the base 22 at the front end 28 is greater than the width of the base of the back end 30.

In some embodiments, the length of the base 22 is between one-and-a-half inches and three-and-a-half inches, the width of the base 22 at the back end 30 is between two inches and four inches, the width of the base 22 at the front end 28 is between two-and-a-half inches and five inches, and each of the right sidewall 24 and the left sidewall 26 extend in the upward direction above the base 22 by a height between a half inch to one-and-a-half inches.

The metal plate 98 of the device 20 may be fabricated using 10- to 18-gauge stainless steel. Other combinations of dimensions are feasible, as well as using other material and thicknesses.

In some embodiments, the length of the base 22 is substantially two-and-a-quarter inches, the width of the base 22 at the back end 30 is substantially three-and-one-eighth inches, the width of the base at the front end 28 is substantially three-and-seven-eighths inches, and each of the right sidewall 24 and the left sidewall 26 extend in the upward direction by a height of substantially three-quarters of an inch above the base 22.

FIG. 27 illustrates a steel plate 98 being utilized to manufacture a device 20 for protecting the sole of footwear 12 according to an embodiment where the fold lines 32, 34 for forming the sidewalls 24, 26 are parallel with each other according to an exemplary embodiment. Although the angled sidewalls 24, 26 as shown in the previous diagrams are beneficial to help the device 20 fit on most types of footwear 12, other embodiments are also possible where the sidewalls 24, 26 are parallel with on another. As shown in FIG. 27, this can be manufactured by folding up the sidewalls 24, 26 along parallel fold lines 32, 34, for example.

In a summary of some exemplary embodiments, a device 20 for protecting footwear 12 is removably attached to a sole 52 of the footwear 12. The device 20 includes a rigid plate 98 forming base 22 and sidewalls 24, 26, and a strap 36 for removably fastening the device 20 to the footwear 12. The device 20 is formed by bending the rigid plate 98 into an approximate U-shape such that the rigid plate 98 has a flat base 22 and upward extending sidewalls 24, 26. In some embodiments, the rigid plate 98 is a metal plate such as stainless steel.

In some embodiments, the top surface 48 of the rigid plate 98 forms a base 22 that contacts the bottom surface of the footwear 12, and the top surface 48 of the base 22 has an anti-slip strip to provide additional friction between the sole 52 of the footwear 12 and the device 20. A first end of the strap 36 is mechanically fastened to a first sidewall 24 of the rigid plate 98 using at least one rivet or other snap 38, and a second end of the strap 36 is mechanically fastened to a second wall 26 of the rigid plate 98 using at least one rivet or other snap 38. The strap 36 may be fabricated from elastic or non-elastic material, and, in some embodiments, is formed by two strap pieces 36a,b with an attachment means such as a buckle 88, 92 therebetween.

The bottom surface 50 of the base 22 may have a plurality of traction protrusions 96 to prevent slipping between the bottom surface 50 of the device 20 and the shovel 58 to prevent injuries. As well the traction protrusions 96 provide traction for the wearer when they are simply walking on the ground. In some embodiments, the traction protrusions are fabricated by stamping ridges on to the rigid plate 98.

Work boots 12 also become loose overtime with use as the user is constantly wiggling their foot to dig into the ground. This increases the chances of the boots 12 not fitting properly and the worker may injure their ankle. The strap 36 used to fasten the device 20 around the boot 12 has an added benefit of providing additional tension to the boot 12, so they still fit well for the user.

When formed in two pieces 36a,b, the first strap piece 36a may have a buckle 88, 92 such as a buckle tongue and the second strap may have a keeper, a free loop, and adjustment holes for receiving the buckle tongue according to an exemplary embodiment.

The metal plate 98 forming the base 22 may have ridges on either the top or bottom surfaces 48, 50 in some embodiment as a friction increasing means.

H-brackets 74 such as shown in FIG. 14 may be utilized for fastening the strap pieces 36 to the metal plate sidewalls 24, 26 according to an exemplary embodiment. In some embodiments, the first sidewall 24 attaches to a first strap 36a having a male clip at a first end. The second sidewall 26 attaches to a second strap 36b having a female clip at a first end. The male and female clips are used to removably fasten the device 20 to the shoes. A second end of the first strap 36a is attached to the first sidewall 24 of the device using an H-bracket 74. A second end of the second side strap 36b is attached to the second sidewall 26 of the device 20 using an H-bracket 74. The H-brackets 74 are connected to the metal plate 98 with rivets or other snaps 38. In another embodiment, the first end of the first strap 36a has hook fasteners and the first end of the second strap 36b has loop fasteners. In yet another embodiment, the second strap 36b is omitted and the fastener is attached directly to the device 20. For example, the female clip or the loop fastener are attached directly to the second sidewall wall 26 of the device 20.

In an exemplary embodiment, a device 20 for protecting footwear 12 includes a base 22 with length less than a length of the sole 52 of the footwear 12 to be protected and a width greater than a width of the sole 52. The base 22 has a top surface 48 for placement adjacent the sole 52 of the footwear 12 and a bottom surface 50 for abutting against a foot-driven tool 58. A right sidewall 24 extends upward from the right side 32 of the base 22, and a left sidewall 26 extends upward from the left side 34 of the base 22. A strap 36 is attached to the right sidewall 24 and the left sidewall 26 for looping around the footwear 12 to hold the top surface 48 of the base 22 adjacent the sole 52 of the footwear 12. In this way, a user can impact the foot-driven tool 58 with the device 20 instead of the sole 52 of the footwear 12 thereby protecting the sole 52 against damage, and the sidewalls 24, 26 prevent the device 20 laterally sliding off the sole 52.

Although the invention has been described in connection with preferred embodiments, it should be understood that various modifications, additions and alterations may be made to the invention by one skilled in the art without departing from the spirit and scope of the invention.

For example, both the downward facing protrusions 76 of FIG. 15 and the upward facing protrusions 76 of FIG. 16 may be utilized on a single device 20. Likewise, other types of friction increasing and/or traction means may simultaneously be utilized on both the upper surface 48 of the base 22 and the bottom surface 50 of the base 22.

Although the above embodiments have focused on manufacturing the base 22 and sidewalls 24, 26 utilizing a single piece of hardened metal such as a stainless steel plate 98, other embodiments are also possible utilizing non-integral sidewalls 24, 26. For instance, the sidewalls 24, 26 may be welded or otherwise attached to the base 22 instead of bending the base plate 98 to thereby form the sidewalls 24, 26. Likewise, although stainless steel is beneficial for its strength and resistance to rusting, the base 22 and sidewalls 24, 26 may be fabricated out of any suitable materials.

Means for attaching the strap 36 to the sidewalls 24, 26 can also include rivets in addition to snaps 38.

Although, the base 22 and sidewalls 24, 26 are made from a rigid materials such as metal in the above examples, in some embodiments a non-rigid plate 98 is used. The non-rigid plate 98 may be a rubber plate, a silicone plate, a leather plate, a fabric plate, or a combination thereof, for example. In yet another embodiment, the base plate maybe substantially flat such that it does not have the sidewalls 24, 26 (i.e., the sidewalls 24, 26 are omitted in some embodiments).

In some embodiments, the strap 36 is made from an elastic material, but other types of straps 36 can also be used. Examples of types of straps 36 include a bungee strap, a fabric strap, a leather strap, a silicone strap, a plastic strap, or a combination thereof, for example.

In yet other embodiments, the fastening mechanisms for attaching the strap 36 to the device 20 include a clasp or an inline clasp. Likewise, in other embodiments, the first and second sidewalls 24, 26 have a hole and a string is fastened to the device 20 by passing a string through a hole and tying a knot on the inside surface of the device 20.

The device 20 may be permanently mounted on the footwear 12 by mean of mechanical fastening such as using rivets, glue, stitches, staples, or a combination thereof, for example. Other means of mechanical fastening are possible for fastening the device 20 to the footwear 12. For example, the device 20 may be mechanically fastened using clips on the side of the boot 12. In yet another embodiment, the device 20 is screwed to the side or bottom of the boot 12.

Although the above description as focused on embodiments where the device 20 is placed in a mid-sole 52 area during usage, the device 20 may also be placed anywhere along the sole 52 in different use-case scenarios. For instance, other users may prefer to use a different part of the sole 52 to push down on the shovel 58.

In some embodiment, the base 22 of the device 20 has notches cut-out in the corners for better fit with rubber boots.

All combinations and permutations of the above described features and embodiments may be utilized in conjunction with the invention.

1. A device for protecting a sole of a footwear against damage caused from impacting a foot-driven tool, the device comprising:
a base having a front end and a back end wherein a length of the base between the front end and the back end is less than a length of the sole of the footwear, the base further having a right side and a left side wherein a width of the base between the right side and the left side is greater than a width of the sole of the footwear, and the base further having a top surface facing an upward direction for placement adjacent the sole of the footwear and a bottom surface facing a downward direction for abutting against the foot-driven tool during usage of the foot driven tool;
a right sidewall extending in the upward direction from the right side of the base;
a left sidewall extending in the upward direction from the left side of the base; and
a strap attached to the right sidewall and the left sidewall for looping around the footwear to thereby hold the top surface of the base adjacent the sole of the footwear;
whereby, while the strap is holding the top surface of the base adjacent the sole of the footwear, a user can impact the foot-driven tool with the device instead of the sole of the footwear thereby protecting the sole against damage, and the right sidewall and the left sidewall prevent the device from laterally sliding off the sole of the footwear.

2. The device of claim 1, wherein the top surface of the base is substantially flat and each of the right sidewall and the left sidewall extend in the upward direction at an angle between one hundred degrees and one hundred and twenty degrees from the top surface of the base.

3. The device of claim 2, wherein each of the right sidewall and the left sidewall extend in the upward direction at substantially one hundred and ten degrees from the top surface of the base.

4. The device of claim 1, wherein, in addition to extending in the upward direction, each of the right sidewall and the left sidewall further extend outward away from one another.

5. The device of claim 1, wherein the base, the right sidewall, and the left sidewall are together formed by an integral piece of material.

6. The device of claim 5, wherein:
the integral piece of material is substantially rectangular; and
the right sidewall and the left sidewall are each respectively formed by an upwards bending section of the integral piece of material.

7. The device of claim 6, wherein the integral piece of material is substantially rectangular with rounded corners.

8. The device of claim 1, wherein a first width of the base at the front end is greater than a second width of the base of the back end.

9. The device of claim 1, wherein the right sidewall and the left sidewall are each substantially running along one of a plurality of two straight lines from the back end to the front end of the base, the two straight lines being such that the right sidewall and the left sidewall are angled away from each other at the front end and are angled toward each other at the back end.

10-11. (canceled)

12. The device of claim 1, wherein a top surface of the base has an indicator showing a foot direction to guide the user to position the device with the front end of the base directed toward a front end of the footwear.

13-15. (canceled)

16. The device of claim 1, wherein the bottom surface of the base has a means for increasing friction with the foot-driven tool.

17. The device of claim 16, wherein the means for increasing friction includes one or more etched groves.

18. The device of claim 17, wherein the etched groves are in formed in a symmetrical grid pattern.

19. The device of claim 16, wherein the means for increasing friction includes one or more protrusions.

20. The device of claim 16, wherein the means for increasing friction includes one or more recesses.

21. The device of claim 16, wherein the means for increasing friction includes a plurality of holes passing through the base from the bottom surface to the top surface.

22. (canceled)

23. The device of claim 1, wherein the strap is formed by a first strap part attached to the right sidewall, a second strap part attached to the left sidewall, and a means for attaching the first strap part and the second strap part together.

24. The device of claim 23, wherein the means for attaching includes a buckle.

25-28. (canceled)

29. The device of 28 claim 1, wherein the base is made of a steel plate.

30. (canceled)

31. A method of manufacturing the device of claim 1, the method including:
cutting a substantially rectangular piece of metal;
drilling a plurality of holes on each of a right section and a left section the substantially rectangular piece of metal; and
bending up the right section and the left section of substantially rectangular piece of metal to thereby respectively form the right sidewall and the left sidewall.

32. (canceled)
